(19) United States
(12) Patent Application Publication
(10) Pub. No.: US 2006/0271560 A1
(43) Pub. Date: Nov. 30, 2006

(54) Location based provision of on-demand content

(76) Inventor: Don Mitchell, Bellevue, WA (US)

Correspondence Address: MANELLI DENISON & SELTER PLLC,, 7th Floor, 2000 M Street, N.W., Washington, DC, 20036-3307, US

(21) Appl. No.: 11/440,083

(22) Filed: May 25, 2006

Related U.S. Application Data
(60) Provisional application No. 60/684,184, filed on May 25, 2005.

(51) Int. Cl. G06F 17/30

(52) U.S. Cl. 707/10

(57) ABSTRACT

Content streams are fed to a user on-demand based on the user's current or selected location using SIP and/or, Internet Protocol (IP) & RSS. In particular, a user receives “feed” content based on arrival in a given location. The content is provided to the user, e.g., using Really Simple Syndication (RSS) or Session Initiation Protocol (SIP). In disclosed embodiments, the subscriber receives location relevant content from a (1) “push” based upon profile and a network based indication of the users current or most recent location/proximity or a (2) “pull” based upon the users preferences in a profile and the ability for the user to either indicate in their “pull” request, or for the “pull” request to query a network data store, with the users current or most recent location/proximity.

This application claims priority from U.S. Provisional Appl. No. 60/684,184, filed May 25, 2005, entitled “Location Based On Demand Provision Of Content”, by Don Mitchell, the entirety of which is expressly incorporated herein by reference.

### BACKGROUND OF THE INVENTION

1. Field of the Invention

This invention relates generally to wireless data and Internet Protocol (IP) multimedia services. More particularly, it relates to location based on-demand services.

2. Background of the Related Art

Really simple syndication (RSS) is a family of web feed formats, specified in extensible markup language (XML) and used for web syndication. RSS is used by many content providers providing information such as news websites, weblogs, podcasting, vodcasting, broadcasting, screencasting, vlogging, and MP3 blogs. Web feeds are widely used by the weblog community to share the latest entries' headlines or their full text, and even attach multimedia files. Web feeds provide web content or summaries of web content together with links to the full versions of the content, and other metadata. RSS, in particular, delivers this information as an XML file called an RSS feed, webfeed, RSS stream, or RSS channel. Current versions of RSS are referred to as RSS 2.0.

Many companies are turning to RSS for delivery of their news, replacing email and fax distribution. The use of RSS has spread to many of the major news organizations, including Reuters, CNN, PR Newswire, Business Wire, and the BBC. These providers allow other websites to incorporate their “syndicated” headline or headline-and-short-summary feeds under various usage agreements. RSS is now used for many purposes, including marketing, bug-reports, or any other activity involving periodic updates or publications.

RSS-aware programs are available for various operating systems. Client-side readers and aggregators are typically constructed as standalone programs or extensions to existing programs such as web browsers. Using RSS, a user merely need web access to receive a given content feed. An aggregator may be used to combine existing web feeds into a new feed, e.g., taking all baseball related items from several sports feeds and providing a new baseball feed. Many news aggregators such as My Yahoo! publish subscription buttons for use on Web pages to simplify the process of adding news feeds.

Thus, user's of conventional systems access on-demand feed content when they want by accessing the feed content source that they are interested in. While this is advantageous, it requires a user to know the identity of a given content source, and to access that content source when they want to hear and/or see it.

There is a need for technology that advances the concepts of subscription and on-demand services to provide content information more relevant and suitable to a given user.

### SUMMARY OF THE INVENTION

In accordance with the principles of the present invention, a subscriber is provided with the capability to subscribe to “feed” content using, e.g., Really Simple Syndication (RSS) or Session Initiation Protocol (SIP).

In one aspect of the invention from a network perspective, a location sensitive content feed is provided to a user by obtaining a current location of the user. The current location is compared to a preset file associating a predetermined current location with a desire to receive a content feed from a given content feed source. The content feed is provided to the user contemporaneous with the user being in or around the current location.

From a perspective of a user, content feed is received when at a predefined location by predefining an association of a given location to a source of content feed. When a current location matches the given location, the content feed is received.

### BRIEF DESCRIPTION OF THE DRAWINGS

FIG. 1 is a block diagram showing the provision of location sensitive feed content to a user based on their current location, in accordance with the principles of the present invention.

FIG. 2 shows a conventional LoCation Services (LCS) request.

FIG. 3 depicts a feed database maintained by an appropriate feed source, in accordance with the principles of the present invention.

FIG. 4 shows relevant portions of an exemplary user profile file defining content feed for a particular user when at a given location or within a defined locale, in accordance with the principles of the present invention.

FIG. 5 is a block diagram showing exemplary elements of the user's request for current location shown in FIG. 1.

FIG. 6 is a block diagram showing exemplary elements of the lookup for a specific feed based on a user's current location shown in FIG. 1.

### DETAILED DESCRIPTION OF ILLUSTRATIVE EMBODIMENTS

The present invention allows the augmentation of RSS type feeds with selection among them being based on the user being in a given location or locale. The content feed can even be triggered by the user's entry into a defined location.

In a general implementation a given user may be associated with their desired web feed(s), and the location(s) that they would like to have such web feeds delivered to them. In a more specific application, the user may select a broad category of feed (e.g., weather, sports, headline news, etc.), and their wireless provider (or a third party feed source) may provide a generic feed the that user selected based on the location that the user is currently in.

In the general implementation, a user may set their desired web feed on an individual basis (e.g., by use of a user's profile file maintained by their wireless carrier), or on a general population basis by use of an access file relating to all user's maintained by a wireless carrier.

In either implementation, content streams are fed to a user on-demand based on the user's current or selected location using SIP and/or, Internet Protocol (IP) & RSS. The present invention provides the capability of a user to subscribe to receive “feed” content based on arrival in a given location.

The content is provided to the user, e.g., using Really Simple Syndication (RSS) or Session Initiation Protocol (SIP). In disclosed embodiments, the subscriber receives location relevant content from a (1) “push” based upon profile and a network based indication of the users current or most recent location/proximity or a (2) “pull” based upon the users preferences in a profile and the ability for the user to either indicate in their “pull” request, or for the “pull” request to query a network data store, with the users current or most recent location/proximity.

In accordance with the principles of the present invention, a location context sensitive content feed (referred to herein as “Zone.Info”) is provided to a user based upon their presence at a given location associated with the content feed. The location sensitive content feeds may provide general information, or personal information.

Exemplary content feeds include, e.g., weather information based on the current locale of the user, sports relevant to the region where the user is now, etc. Exemplary personal information content feeds include, e.g., favorite audio content that the user want's to listen to when on their way to work, etc.

For general content feeds, the user may first subscribe to a given feed. Examples include ‘weather’, ‘sports’, ‘headline news’, etc. Content is developed relevant to a given location, region, locale, etc. For instance, weather forcasts may be obtained on a state-by-state basis. Thus, there would be 50 different possible weather feeds to be provided to the subscriber. The particular feed to be forwarded to the subscribing user would be selected automatically based on the current location of the subscribing user.

The location information may be augmented with date, time and/or day information such that a certain feed might be provided during certain hours, days of week, etc., and another feed at other times, all for a given location.

For example, when a user is driving from Seattle to Portland, they will get the weather audio content delivered to their wireless device based upon a profile (e.g. when I am 5 miles from a major city; or every hour, etc.) and the device will obtain, queue the content, and then provide the option for the user to listen to, view or read the delivered content.

For personal content feeds, the user pre-establishes a profile based upon date, time and/or day of week, and the relevant location for the receipt and consumption of defined audio/video/text/graphical data. For example, when a mobile individual wants to get the mall specials list when entering Bellevue Square Mall.

The content feeds may be hosted by the user's service subscriber or other content source. In a more general sense, the user may designate one or more content feed sources generally available on the Internet. For instance, content feed providing a several minute audio clip providing weather forecast information may be hosted by the service provider, whereas general audio/music may be provided by a suitable commercial source, e.g., a radio station that streams on the Internet.

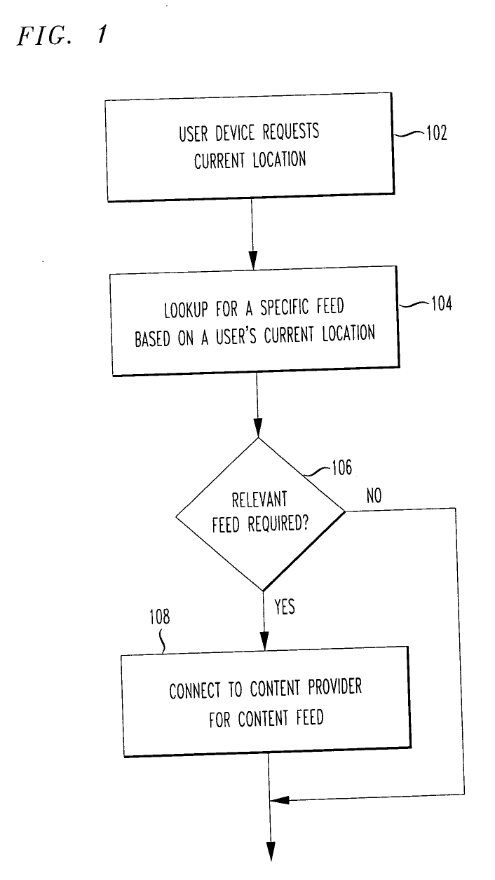

FIG. 1 is a block diagram showing the provision of location sensitive feed content to a user based on their current location, in accordance with the principles of the present invention.

In particular, as depicted by step 102 in FIG. 1, a user device requests a current location.

In step 104, a lookup is performed for a specific feed desired by the user based on their current location.

In step 106 it is determined whether, based on the user's current location, a content feed is to be accessed. If not, the process ends. If so, in step 108 the content provider is accessed and requested to feed the relevant content feed to the user.

A given user's desired on-demand content can be selected and provided based on their profile file containing a matching date, time, day of week, etc., together with a match between their actual location and a location or area defined in their profile file.

Location information relates to absolute coordinates of a wireless device. An exemplary request for current location may read as: http://www.zones.info/weather/rss/index.php?uid=3694&lat=47.37&Ion=122.20

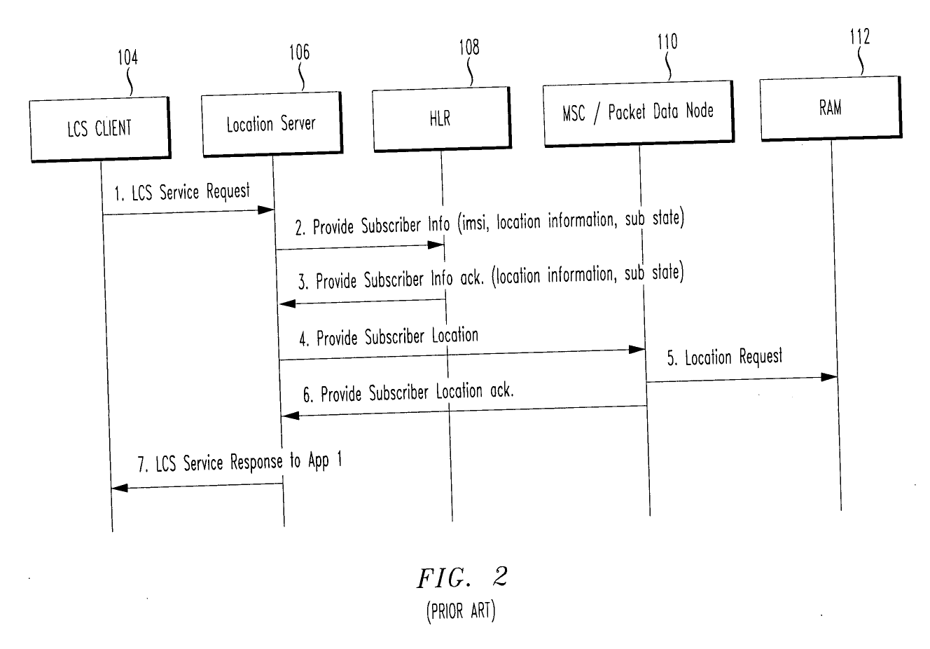

FIG. 2 shows a conventional LoCation Services (LCS) request.

In particular, as shown in FIG. 2, a location server 106 requests location information regarding a particular mobile subscriber (MS) from a core network node, e.g., from a Mobile Switch Center (MSC) 110. Requested information regarding a particular wireless device (MS) may include, e.g., attach, detach, and location area update. The location server 106 may also request information regarding the wireless device such as attach, detach and/or location area update from a Packet Date Node (e.g., SGSN, GGSN, or PDSN), or help the device calculate x/y direction.

Typically, location information regarding a particular wireless device is requested of a home location register (HLR).

As shown in step 1 of FIG. 2, a locations services client sends a message to a location server.

In step 2, a location server 106 sends a Provide Subscriber Info message to a Home Location Register 108, requesting subscriber information regarding a particular subscriber.

In step 3, the carrier's Home Location Register (HLR) 108 provides the subscriber information for the requested subscriber back to the location server 106.

In step 4, location information regarding the requested subscriber is requested to either an MSC or Packet Data node 110. The MSC or Packet Data Node preferably provides precise location information using, e.g., a global positioning satellite (GPS), triangulation techniques, or other relevant locating technology, or helps the device calculate X/Y direction.

In step 5, the location request is forwarded to the Radio Access Network (RAN) 112 if needed.

In step 6, precise, updated location information regarding the requested subscriber is sent to the location server (LS) 106.

In step 7, an ultimate response to the original location request is sent to the LCS client 104 that initially requested the location information.

One conventional technique for a given application to track position of a given subscriber is for the application to periodically “poll” the mobile device for its position. Conventional polling techniques utilize a system within the wireless network that periodically requests updated location information from the desired subscriber. The polling is typically performed periodically, e.g., every N minutes.

Location requests where the location response (responses) is (are) required after a specific event has occurred is sometimes referred to as Deferred Location requests. The event may or may not occur immediately. This event may also be referred to as a Location Trigger. Deferred services are useful when a client would like to know the location of a target device at certain intervals during a specific period of time. For example, a client may want to know the location of a target device every 30 minutes during the hours of 08:00 and 17:00.

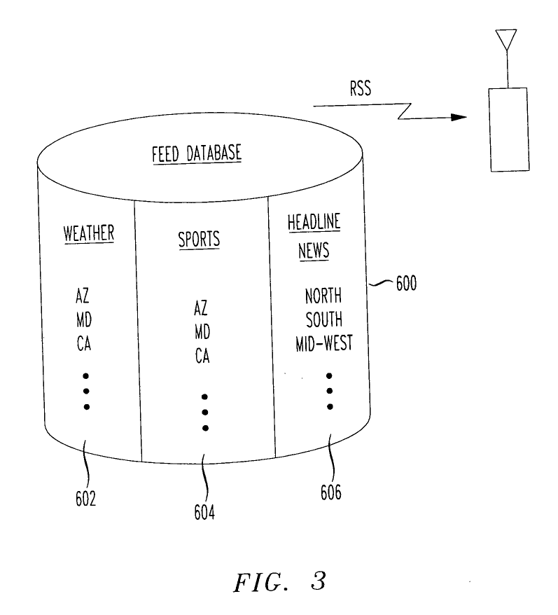

FIG. 3 depicts a feed database maintained by an appropriate feed source, in accordance with the principles of the present invention.

In particular, as shown in FIG. 3, a feed database 600 may contain a plurality of general categories of feed information. In a given example, feed content may be queued in the feed database 600 relating to weather 602, sports 604, and headline news 606. Within each of the relevant general categories of Zone.info feed information, content relevant to specific locations, areas or locales may be queued.

For instance, a subscriber may want a weather feed relating to weather in Arizona (AZ) when their location indicates that they are currently in Arizona. Similarly, a weather feed relating to weather in Maryland (MD) would be provided to the user when they are currently determined to be located in Maryland. A weather feed relating to weather in California (CA) would be provided to them when they are in California, etc.

The same or different subscriber may subscribe to a sports feed relevant to their current location. In such a case, sports feeds relating to teams in Arizona (AZ), or Maryland (MD), or California (CA) may be provided when the user is currently located in those respective states.

The subscriber might subscribe to regional headline news relevant to areas of the country, e.g., the Northern portion of the country, the Southern portion of the country, the mid-western portion of the country, etc.

While the areas depicted in FIG. 3 are delineated along state boundaries, these areas may of course be delineated along any appropriate physical boundary definable in latitude/longitude coordinates, in accordance with the principles of the present invention.

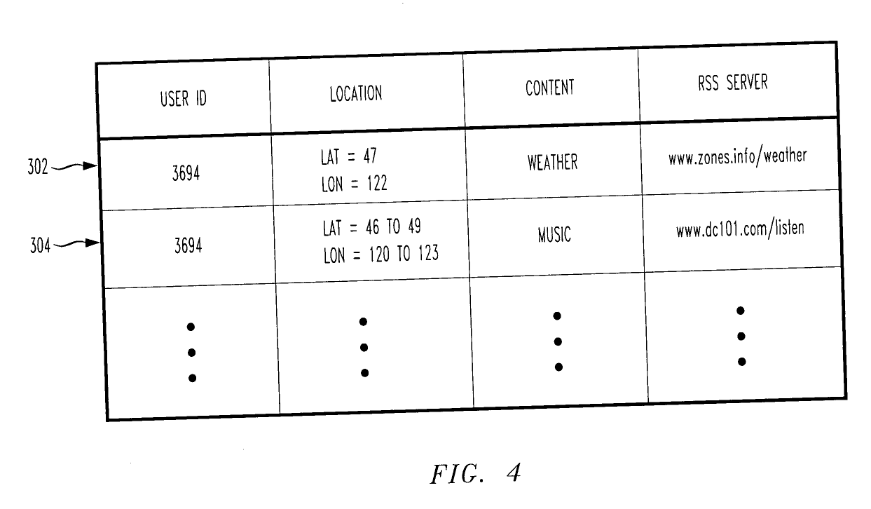

FIG. 4 shows relevant portions of an exemplary user profile file defining content feed for a particular user when at a given location or within a defined locale, in accordance with the principles of the present invention.

In particular, as shown in FIG. 4, the invention may be expanded to allow personalization by the user, not only to receive automatically changed feed content in general categories as they physically move about, but also (or alternatively) to receive feed content from third party sources available over the Internet.

In a disclosed example, the user establishes a user profile with their wireless service (or content feed) provider. The provider then maintains a plurality of user profiles in an appropriate database.

As depicted in the user profile database entries shown in FIG. 4, an exemplary user profile database includes two entries, in the example both for the same user having the unique user ID# 3694.

Pursuant to the first entry 302, when the user is determined to be at location LAT=47, LON=122, weather content accessed over the Internet from a service provider providing the “Zones.Info” service, e.g., at www.zones.info/weather. A second entry 304 provides a music feed from commercial radio source www.DC101.com/listen if/when the user is determined to be at a current location within the area or locale defined by LAT=46 to 49, LON=120 to 123. (Of course, other ranges, other shapes of ranges, etc. may be defined in the location portion of the user's profile, within the context of the present invention.)

The content feeds may be defined in a suitable user profile file, including a date/time of use for the defined content feed. For instance, certain content feed may be desired during work hours, M-F 9 AM to 5 PM, while located on the way to work. Other hours while in the same locations the user might want to hear different content feed.

Relevant location may be defined broadly, such as when in a given state, or county, or city. Location may also be defined by street names, street address, school district, Zip code. In a more advanced implementation, location definitions for reception of given content feeds may be defined by the user in given polygonal shapes drawn on a map. Alternatively, the location may be defined as a given latitude/longitude (Lat/Lon), with a tolerance band of a given amount in each of the latitude and longitude directions.

Preferably the user is provided with the content feed upon their request, to avoid repetitive feeds to the same user if/when they are not mobile.

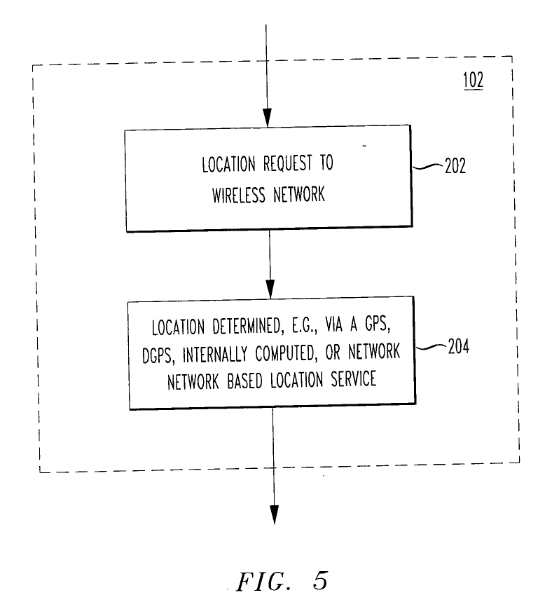

FIG. 5 is a block diagram showing exemplary elements of the user's request for current location shown in FIG. 1.

In particular, as shown in FIG. 5, upon a user device requesting their current location as depicted in step 102 of FIG. 1, a location request is sent to the wireless network 202. In step 104, the location is determined by any suitable location determining technique that is preferred by the wireless carrier. Exemplary location determining techniques include assisted GPS, DGPS, an internal computation (e.g., based on cell tower), or network based location service (e.g., a position determining element (PDE)).

Note that while the location request is sourced by the user themselves in the disclosed embodiments, it is also within the principles of the present invention to encompass a location request sourced by an external application program that happens to request the current location of the user. It is preferably that such external location request also initiate a comparison of the location with the entries in the profile database (FIG. 2), and if a match is made to cause the context feed to be accessed and provided to the user. In such case, it is preferable that the user be provided with an “opt in” selection so that they actually hear/see the context feed only if they want it at that particular time.

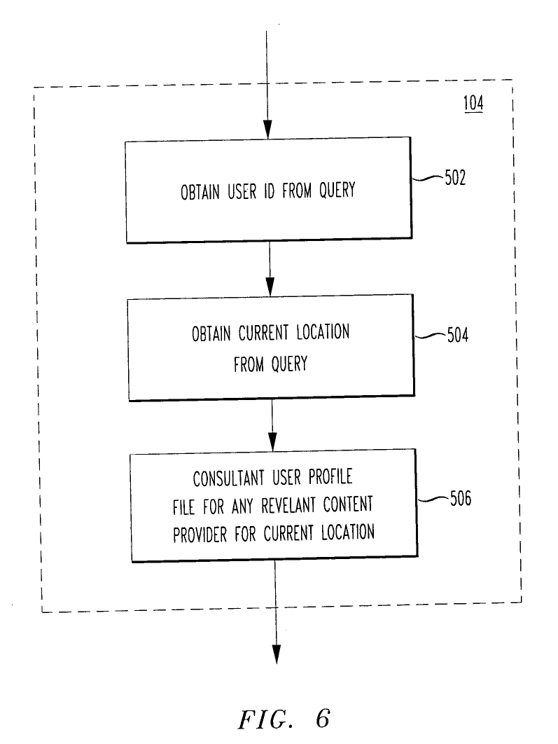

FIG. 6 is a block diagram showing exemplary elements of the lookup for a specific feed based on a user's current location shown in FIG. 1.

In particular, as shown in FIG. 6, the unique user ID# is obtained from the location query (step 502), as is the resultant current location (step 504). Armed with the user ID and current location, any/all profile entries for that particular user are consulted for the need to provide a content feed from any desired content source (step 506).

The use of location sensitive content feeds have particular applicability with mobile consumers.

While the invention has been described with reference to the exemplary embodiments thereof, those skilled in the art will be able to make various modifications to the described embodiments of the invention without departing from the true spirit and scope of the invention.

What is claimed is:

1. A method of providing a location sensitive content feed to a user, comprising:
obtaining a current location of said user;
comparing said current location to a preset file associating a predetermined current location with a desire to receive a content feed from a given content feed source; and
providing said content feed to said user contemporaneous with said user being in or around said current location.

2. The method of providing a location sensitive content feed to a user according to claim 1, wherein:
said content feed is provided using Really Simple Syndication (RSS).

3. The method of providing a location sensitive content feed to a user according to claim 1, further comprising:
receiving a query for said current location of said user.

4. The method of providing a location sensitive content feed to a user according to claim 3, wherein:
said query for said current location of said user is received from said user.

5. The method of providing a location sensitive content feed to a user according to claim 3, wherein:
said query for said current location of said user is received from an external application.

6. A method of receiving content feed when at a predefined location, comprising:
predefining an association of a given location to a source of content feed; and
when a current location matches said given location, receiving said content feed.

7. The method of receiving content feed when at a predefined location according to claim 6, wherein:
said content feed is provided using Really Simple Syndication (RSS).

8. The method of receiving content feed when at a predefined location according to claim 6, wherein:
said predefined location comprises an area defined by a city boundary.

9. The method of receiving content feed when at a predefined location according to claim 6, wherein:
said predefined location comprises an area defined by a state boundary.

10. The method of receiving content feed when at a predefined location according to claim 6, wherein:
said predefined location is defined by at least one street address.

11. The method of receiving content feed when at a predefined location according to claim 6, wherein:
said predefined location is defined by a plurality of streets.

12. Apparatus for providing a location sensitive content feed to a user, comprising:
means for obtaining a current location of said user;
means for comparing said current location to a preset file associating a predetermined current location with a desire to receive a content feed from a given content feed source; and
means for providing said content feed to said user contemporaneous with said user being in or around said current location.

13. The apparatus for providing a location sensitive content feed to a user according to claim 12, wherein:
said content feed is provided using Really Simple Syndication (RSS).

14. The apparatus for providing a location sensitive content feed to a user according to claim 12, further comprising:
means for receiving a query for said current location of said user.

15. The apparatus for providing a location sensitive content feed to a user according to claim 14, wherein:
said means for receiving receives said query for said current location of said user from said user.

16. The apparatus for providing a location sensitive content feed to a user according to claim 14, wherein:
said means for receiving receives said query for said current location of said user from an external application.

17. Apparatus for receiving content feed when at a predefined location, comprising:
means for predefining an association of a given location to a source of content feed; and
means for receiving said content feed when a current location matches said given location.

18. The apparatus for receiving content feed when at a predefined location according to claim 17, wherein:
said content feed is provided using Really Simple Syndication (RSS).

19. The apparatus for receiving content feed when at a predefined location according to claim 17, wherein:
said predefined location comprises an area defined by a city boundary.

20. The apparatus for receiving content feed when at a predefined location according to claim 17, wherein:
said predefined location comprises an area defined by a state boundary.

21. The apparatus for receiving content feed when at a predefined location according to claim 17, wherein:
said predefined location is defined by at least one street address.

22. The apparatus for receiving content feed when at a predefined location according to claim 17, wherein:
said predefined location is defined by a plurality of streets.
